(19) United States
(12) Patent Application Publication
(10) Pub. No.: US 2026/0176091 A1
(43) Pub. Date: Jun. 25, 2026

(54) HARNESS FOR SUPPORTING A GAS CANISTER

(71) Applicant: Henry Flowers, Jr., Conroe, TX (US)

(72) Inventor: Henry Flowers, Jr., Conroe, TX (US)

(21) Appl. No.: 18/987,894

(22) Filed: Dec. 19, 2024

(51) Int. Cl. B65G 65/23; A45F 5/10

(52) U.S. Cl. CPC B65G 65/23; A45F 5/10; A45F 2005/1013

(57) ABSTRACT

A harness for supporting a gas canister includes a guide strap, a support strap, a securing strap, and a handle. The guide strap is designed to be wrapped around a front surface, a rear surface, a first side surface, and a second side surface of a gas canister body. The support strap is coupled to the guide strap. The support strap is designed to be wrapped around a bottom surface, the front surface, and the rear surface of the gas canister body. The securing strap is designed to be wrapped around the bottom surface, the first side surface, and the second side surface of the gas canister body, and around a top portion of the gas canister body adjacent a handle of the gas canister body. The guide strap, support strap, and securing strap are selectively adjustable in length. A handle is attached to the support strap.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to gas canisters and more particularly pertains to a new harness for securely holding a gas canister. Gas canisters or tanks can be large and difficult to hold. Most all gas canisters include a top handle portion to be held, and some even include a second handle portion. The gas canisters can be even more difficult to control in wet weather as the handles and surfaces are slippery. The harness provides a much more secure way to hold the gas canister. The harness is also adjustable to allow the harness to fit essentially any size and shape of gas canister.

### (2) Description of Related Art Including Information Disclosed under 37 CFR 1.97 and 1.98.

The prior art relates to gas canisters. The prior art, as best understood, does not disclose a harness made up of adjustable straps with a handle connected to the harness.

### (h) BRIEF SUMMARY OF THE INVENTION

An embodiment of the disclosure meets the needs presented above in a harness generally comprising a guide strap, a support strap, a securing strap, and a handle. The guide strap is designed to be wrapped around a front surface, a rear surface, a first side surface, and a second side surface of a gas canister body. The guide strap is selectively adjustable in length. The support strap is coupled to the guide strap. The support strap is designed to be wrapped around a bottom surface, the front surface, and the rear surface of the gas canister body. The support strap is selectively adjustable in length. The securing strap is designed to be wrapped around the bottom surface, the first side surface, and the second side surface of the gas canister body, and around a top portion of the gas canister body adjacent a handle of the gas canister body. The securing strap is selectively adjustable in length. A handle is attached to the support strap. The handle is designed to be positioned at the rear surface of the gas canister body to be grasped by a first hand of a user to tip the gas canister body being held by a second hand of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a harness according to an embodiment of the disclosure.

FIG. 2 is a front view of an embodiment of the disclosure.

FIG. 3 is a top view of an embodiment of the disclosure.

FIG. 4 is a back view of an embodiment of the disclosure.

FIG. 5 is a bottom view of an embodiment of the disclosure.

FIG. 6 is a side view of an embodiment of the disclosure in use.

FIG. 7 shows an example of a gas canister.

### (j) DETAILED DESCRIPTION OF THE INVENTION

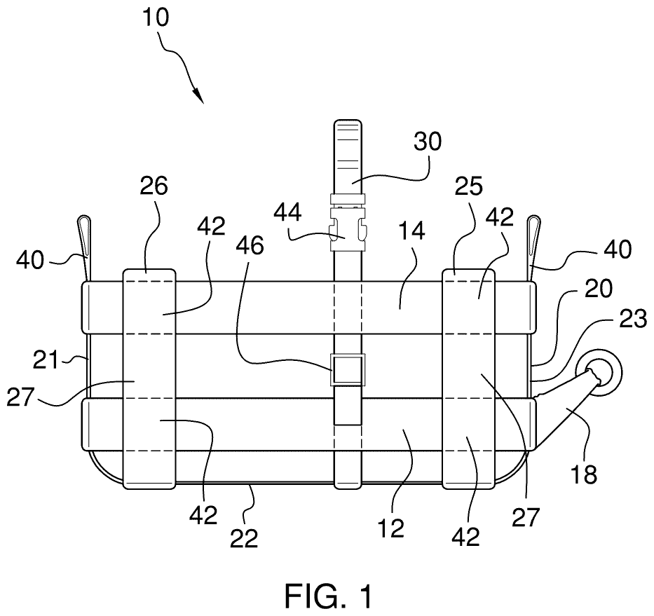

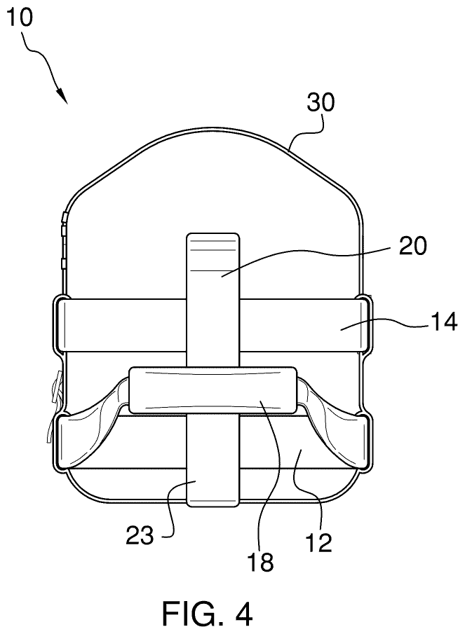

With reference now to the drawings, and in particular to FIGS. 1 through 7 thereof, a new harness embodying the principles and concepts of an embodiment of the disclosure and generally designated by the reference numeral 10 will be described.

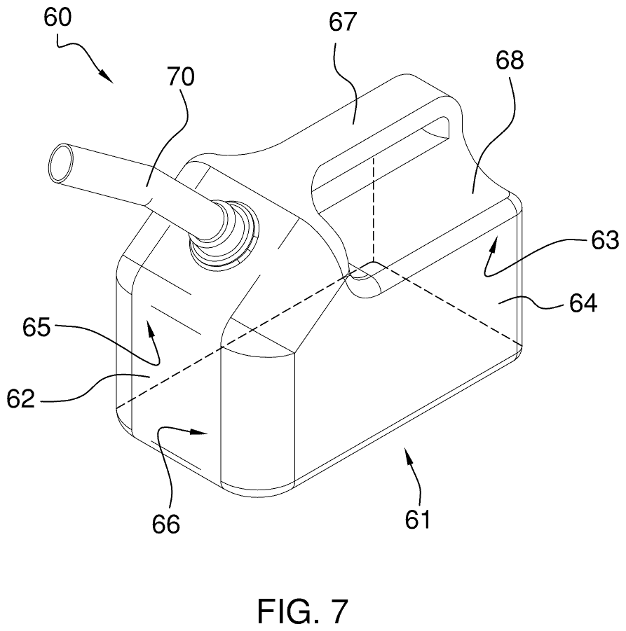

As best illustrated in FIGS. 1 through 7, the harness 10 for supporting a gas canister 60 includes a guide strap 12, a support strap 20, a securing strap 30, and a handle 18. The guide strap 12 is designed to be wrapped around a front surface 62, a rear surface 63, a first side surface 64, and a second side surface 65 of a gas canister body 61. The guide strap 12 is selectively adjustable in length. The support strap 20 is coupled to the guide strap 12. The support strap 20 is designed to be wrapped around a bottom surface 66, the front surface 62, and the rear surface 63 of the gas canister body 61. The support strap 20 is selectively adjustable in length. The securing strap 30 is designed to be wrapped around the bottom surface 66, the first side surface 64, and the second side surface 65 of the gas canister body 61, and around a top portion 68 of the gas canister body 61 adjacent a grip portion 67 of the gas canister body 61. The securing strap 30 is selectively adjustable in length. A handle 18 is attached to the guide strap 12. The handle 18 is designed to be positioned at the rear surface 63 of the gas canister body 61 to be grasped by a first hand 72 of a user to tip the gas canister body 61 being held by a second hand 73 of the user. An example of the gas canister 60 is shown in FIG. 7, though the harness 10 is suitable for use with most any gas canister or can or container.

The support strap 20 includes a front portion 21, a bottom portion 22, and a rear portion 23. The front portion 21 is designed to be positioned against the front surface 62 of the gas canister body 61 and perpendicular to the guide strap 12. The bottom portion 22 is designed to be positioned against the bottom surface 66 of the gas canister body 61. The rear portion 23 is designed to be positioned against the rear surface 63 of the gas canister body 61 and perpendicular to the guide strap 12. Each of the front portion 21 and the bottom portion 22 includes a loop 42 through which the guide strap 12 is passed.

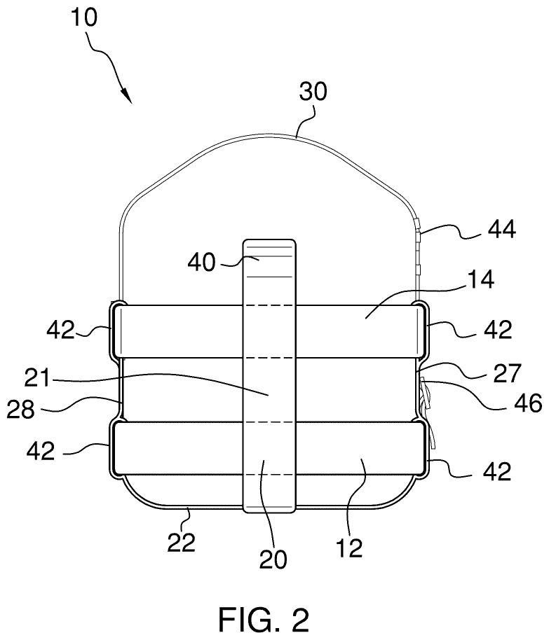

The harness 10 further includes a retention strap 40 that is coupled to an end of the support strap 20. The retention strap 40 is resiliently stretchable and connectable to the securing strap 30 to further support the gas canister body 61. In use, the retention strap 40 can be stretched and the securing strap 30 can be passed through the loop 42 of the retention strap 40. The stretchability of the retention strap 40 can help hold a taller gas canister 60. In the exemplary embodiment shown in FIG. 2, the retention strap 40 is attached to and forms part of the support strap 20. However, in another possible embodiment, the retention strap 40 could be a separate elastic cord with hooks that could hook onto the securing strap 30 and the guide strap 12 or the support strap 20.

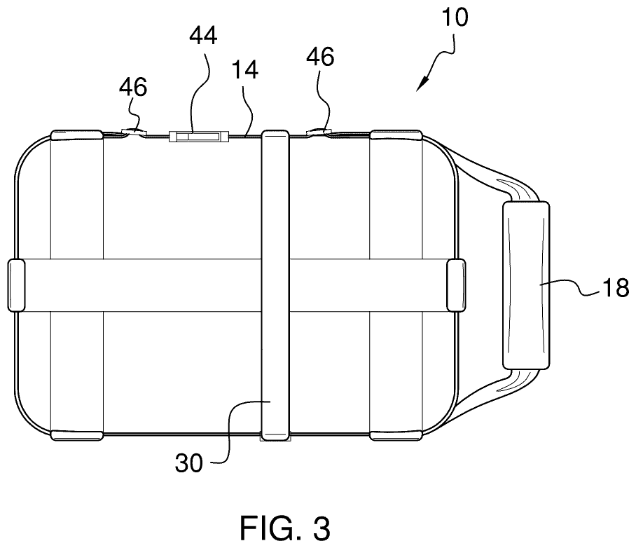

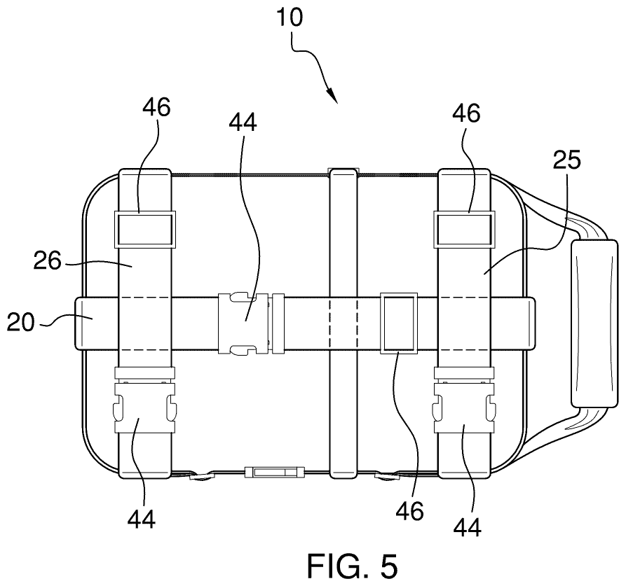

It should be understood that the harness 10 could include one guide strap 12 or multiple guide straps 12, but for convenience of illustration the figures show an exemplary embodiment in which there are two, wherein the guide strap 12 is a first guide strap 12 and there is also a second guide strap 14. To accommodate the second guide strap 14, each of the front portion 21 and the bottom portion 22 of the support strap 20 includes an additional loop 42 through which the second guide strap 14 is passed. In the exemplary embodiment best seen from above and below in FIGS. 3 and 5, respectively, each of the first guide strap 12 and the second guide strap 14 includes a detachable coupler 44 and a slider 46 to adjust the length of each of the first guide strap 12 and the second guide strap 14.

It should also be understood that the harness 10 could include one support strap 20 or multiple support straps 20, but for convenience of illustration the figures show an exemplary embodiment in which there are three, wherein the support strap is a first support strap 20, and there is also a second support strap 25 and a third support strap 26. The second support strap 25 and the third support strap 26 have a different design and positioning in the figures than the first support strap 20, though they all share the similar function of supporting the gas canister 60 from below via their respective bottom portions 22. Unlike the first support strap 20, the second support strap 25 is designed to be wrapped around the bottom surface 66 and the side surfaces 64, 65 of the gas canister body 61 parallel to the securing strap 30. The second support strap 25 is selectively adjustable in length. The second support strap 25 includes a first side portion 27 and a second side portion 28. The first side portion 27 is designed to be positioned against the first side surface 64 of the gas canister body 61 and perpendicular to the first guide strap 12 and the second guide strap 14. The second side portion 28 is designed to be positioned against the second side surface 65 of the gas canister body 61 and perpendicular to the first guide strap 12 and the second guide strap 14. Each of the first side portion 27 and the second side portion 28 of the second support strap 25 includes a pair of the loops 42 through each of which a respective one of the first guide strap 12 and the second guide strap 14 is passed. In the exemplary embodiment in FIG. 1, the third support strap 26 is of the same design as the second support strap 25. The securing strap 30 is positioned between the second support strap 25 and the third support strap 26. As shown in FIG. 3, each of the first support strap 20, the second support strap 25, and the third support strap 26 includes the detachable coupler 44 and the slider 46 to adjust the length of each of the first guide strap 12 and the second guide strap 14. The securing strap 30 also includes the detachable coupler 44 and the slider 46.

It should be understood that the drawings show one exemplary embodiment. However, the guide straps 12, support straps 20, and retention strap 40, collectively referred to as the “straps,” can be of various designs and connected together in different ways. The straps could be affixed to one another, such as by stitching or adhesive. The straps could be interlaced in an over and under weave. The straps could have looped portions through which other straps can be passed. The straps could be made of nylon or other fabric. Some or all of the straps could include resilient material to be stretchable. Some or all of the straps could include couplers, such as the snap fit buckles shown in the figures, and sliders, to allow a user to adjust and set the length of each of the straps. This design is much like the straps of a backpack or similar article. However, other adjustment structures could be used, such as clasps and buttons. In one possible embodiment, none of the straps includes a coupler, but rather all of the straps are either fixed in length to fit a particular size of gas canister or are made of resilient material, such as elastic, to stretch around gas canisters of different shapes and sizes.

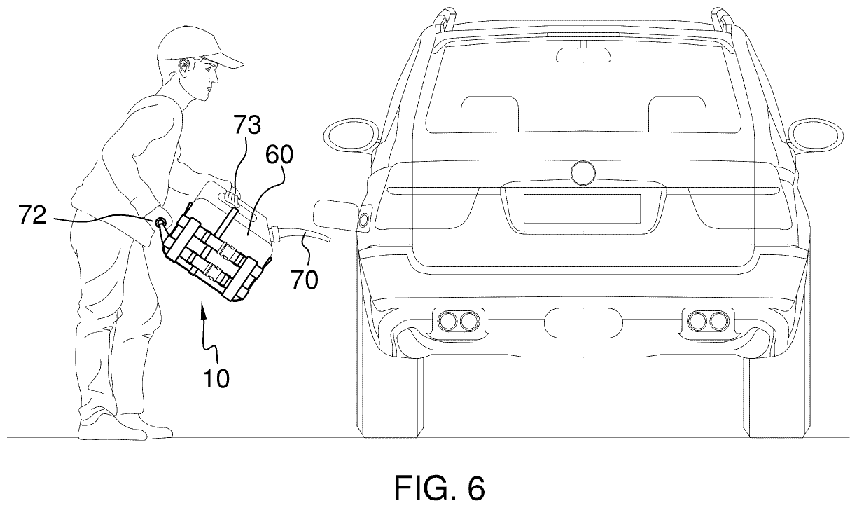

To use the harness 10, the harness 10 is placed around the gas canister 60 as shown in FIG. 6. The various straps are initially loose and then adjusted and tightened about the gas canister 60. The handle 18 is positioned near the rear corner of the gas canister 60 essentially opposite a spout 70 of the gas canister 60. The user can now easily tip the gas canister 60 with the handle 18 using the first hand 72 while holding the gas canister 60 securely in the second hand 73. The adjustability of the harness 10 allows the harness 10 to be placed about a variety of gas canister 60s of different shapes and sizes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A harness for supporting a gas canister comprising:
a guide strap being configured to be wrapped around a front surface, a rear surface, a first side surface, and a second side surface of a gas canister body, said guide strap being selectively adjustable in length;
a support strap being coupled to said guide strap, said support strap being configured to be wrapped around a bottom surface, the front surface, and the rear surface of the gas canister body, said support strap being selectively adjustable in length;
a securing strap being configured to be wrapped around the bottom surface, the first side surface, and the second side surface of the gas canister body, and around a top portion of the gas canister body adjacent a grip portion of the gas canister body, said securing strap being selectively adjustable in length; and
a handle being attached to said guide strap, said handle being configured to be positioned at the rear surface of the gas canister body to be grasped by a first hand of a user to tip the gas canister body being held by a second hand of the user.

2. The harness of claim 1, wherein said support strap includes:
a front portion configured to be positioned against the front surface of the gas canister body and perpendicular to said guide strap,
a bottom portion configured to be positioned against the bottom surface of the gas canister body, and
a rear portion configured to be positioned against the rear surface of the gas canister body and perpendicular to said guide strap, wherein each of said front portion and said bottom portion includes a loop through which said guide strap is passed.

3. The harness of claim 1, further including a retention strap being coupled to an end of said support strap, said retention strap being resiliently stretchable and connectable to said securing strap to further support the gas canister body.

4. The harness of claim 1, wherein:
said guide strap is a first guide strap;
the harness further includes a second guide strap;
said second guide strap is configured to be wrapped around the front surface, the rear surface, and the side surfaces of the gas canister body;
said second guide strap is selectively adjustable in length; and
each of said front portion and said bottom portion of said support strap includes an additional loop through which said second guide strap is passed.

5. The harness of claim 4, wherein each of said first guide strap and said second guide strap includes a detachable coupler and a slider to adjust the length of each of said first and second guide straps.

6. The harness of claim 1, wherein.
said support strap is a first support strap;
the harness further includes a second support strap;
said second support strap is configured to be wrapped around the bottom surface and the side surfaces of the gas canister body parallel to said securing strap;
said second support strap is selectively adjustable in length; and
said second support strap includes:
a first side portion configured to be positioned against the first side surface of the gas canister body and perpendicular to said guide strap,
a bottom portion configured to be positioned against the bottom surface of the gas canister body, and
a second side portion configured to be positioned against the second side surface of the gas canister body and perpendicular to said guide strap, wherein each of said first side portion and said second side portion includes a loop through which said guide strap is passed.

7. The harness of claim 6, wherein:
the harness further includes a third support strap being configured to be wrapped around the bottom surface and the side surfaces of the gas canister body parallel to said securing strap;
said third support strap includes:
a first side portion configured to be positioned against the first side surface of the gas canister body and perpendicular to said guide strap,
a bottom portion configured to be positioned against the bottom surface of the gas canister body, and
a second side portion configured to be positioned against the second side surface of the gas canister body and perpendicular to said guide strap, wherein each of said first side portion and said second side portion includes a loop through which said guide strap is passed; and
said securing strap is positioned between said second support strap and said third support strap.

8. The harness of claim 7, wherein each of said first support strap, said second support strap, and said third support strap includes a detachable coupler and a slider to adjust the length of each of said first and second guide straps.

9. The harness of claim 2, further including a retention strap being coupled to an end of said support strap, said retention strap being resiliently stretchable and connectable to said securing strap to further support the gas canister body.

10. The harness of claim 9, wherein:
said guide strap is a first guide strap;
the harness further includes a second guide strap;
said second guide strap is configured to be wrapped around the front surface, the rear surface, and the side surfaces of the gas canister body;
said second guide strap is selectively adjustable in length; and
each of said front portion and said bottom portion of said support strap includes an additional loop through which said second guide strap is passed.

11. The harness of claim 10, wherein each of said first guide strap and said second guide strap includes a detachable coupler and a slider to adjust the length of each of said first and second guide straps.

12. The harness of claim 11, wherein:
said support strap is a first support strap;
the harness further includes a second support strap;
said second support strap is configured to be wrapped around the bottom surface and the side surfaces of the gas canister body parallel to said securing strap;
said second support strap is selectively adjustable in length; and
said second support strap includes:
a first side portion configured to be positioned against the first side surface of the gas canister body and perpendicular to said first guide strap and said second guide strap,
a bottom portion configured to be positioned against the bottom surface of the gas canister body, and
a second side portion configured to be positioned against the second side surface of the gas canister body and perpendicular to said first guide strap and said second guide strap, wherein each of said first side portion and said second side portion of said second support strap includes a pair of loops through each of which a respective one of said first guide strap and said second guide strap is passed.

13. The harness of claim 12, wherein:
the harness further includes a third support strap being configured to be wrapped around the bottom surface and the side surfaces of the gas canister body parallel to said securing strap;
said third support strap includes:
a first side portion configured to be positioned against the first side surface of the gas canister body and perpendicular to said first guide strap and said second guide strap,
a bottom portion configured to be positioned against the bottom surface of the gas canister body, and
a second side portion configured to be positioned against the second side surface of the gas canister body and perpendicular to said first guide strap and said second guide strap, wherein each of said first side portion and said second side portion of said third guide strap includes a pair of loops through each of which a respective one of said first guide strap and said second guide strap is passed; and
said securing strap is positioned between said second support strap and said third support strap.

14. The harness of claim 13, wherein each of said first support strap, said second support strap, and said third support strap includes a detachable coupler and a slider to adjust the length of each of said first guide strap and said second guide strap.
